(19) United States
(12) Patent Application Publication
(10) Pub. No.: US 2017/0043256 A1
(43) Pub. Date: Feb. 16, 2017

(54) AN AUGMENTED GAMING PLATFORM

(71) Applicants: Robert Paul SEVERN, San Francisco, CA (US); AURASMA LIMITED, Bracknell, Berkshire (GB)

(72) Inventor: Robert Paul Severn, San Francisco, CA (US)

(21) Appl. No.: 15/305,987

(22) PCT Filed: Apr. 30, 2014
(86) PCT No.: PCT/US2014/036219

§ 371 Date: Oct. 21, 2016

(51) Int. Cl. A63F 13/655; A63F 13/327; A63F 13/25

(52) U.S. Cl. CPC A63F 13/655; A63F 13/25; A63F 13/327; A63F 13/213

(57) ABSTRACT

The present disclosure provides a method and a system for an augmented gaming platform. The method and system may capture an image using a computer device with a camera and a display. The method and system may send the image to a matching engine, wherein a trigger is matched to an object in the image. The method and system may return by the matching engine an overlay based on the trigger. The method and system may enter the overlay into an augmented gaming platform.

### BACKGROUND

Augmented reality (AR) is the integration of digital information with the real-world environment. In particular, AR provides a live, direct, or indirect, view of a physical, real-world environment whose elements are augmented by computer-generated sensory input such as sound, video, graphics, or GPS data. AR may include the recognition of an image, an object, a face, or any element within the real-world environment and the tracking of that image by utilizing real-time localization in space. AR may also include superimposing digital media, e.g., video, three-dimensional (3D) images, graphics, text, etc., on top of a view of the real-world environment so as to merge the digital media with the real-world environment.

### BRIEF DESCRIPTION OF THE DRAWINGS

Certain examples are described in the following detailed description and in reference to the drawings, in which:

FIG. 1 is an example block diagram of a computer device for the implementation of multiple triggers from an image into a videogame platform;

FIGS. 2A-2D illustrate an example sequence of capturing and tracking objects from an image taken by a computer device, and implementing the tracked objects on a videogame platform;

FIG. 3 is an example process flow diagram of a method for creating a customizable videogame environment; and

FIG. 4 is an example block diagram showing a non-transitory, computer-readable media that holds code that enables the customizability of a videogame environment.

### DETAILED DESCRIPTION OF SPECIFIC EXAMPLES

Images may be augmented in real-time and in semantic context with environmental elements to enhance a viewer's understanding or informational context. For example, a broadcast image of a sporting event may include superimposed visual elements, such as lines that appear to be on the field, or arrows that indicate the movement of an athlete. Thus, augmented reality (AR) allows enhanced information about the real-world of a user to be overlaid onto a view of the real world.

As discussed above, AR technology adds an additional layer of information, for example, overlaying computer generated graphics on a real-time environment to aid in the interaction with the environment. Thus, AR may include the use of animated environments or videos. Animated may be defined to include motion of portions of an image, as distinguished from something that is merely static. AR may also include incorporating targeted objects from the real world into a virtual world. The virtual world can be configured by and displayed on a computer device. The AR platform of the computer device can utilize multiple-object tracking to configure and track multiple objects or triggers isolated from images of the real world.

Some embodiments described herein enable a user of a computer device to create a customizable videogame environment without further involvement by videogame developers. In some embodiments, an image may be captured using a computer device, where the image may be a static image. The computer device may include a display on which the captured image can be displayed. The image can be sent to a matching engine of the computer device, and triggers defined by an augmented gaming platform can be matched to multiple real-world objects, which may be tracked using multi-object tracking techniques. A set of overlays associated with the trigger defined by the augmented gaming platform can be returned by the matching engine. The overlay can be an input to a videogame software platform running on the computer device, thereby adding customizable variety to a videogame based on how real-world objects in the image are arranged.

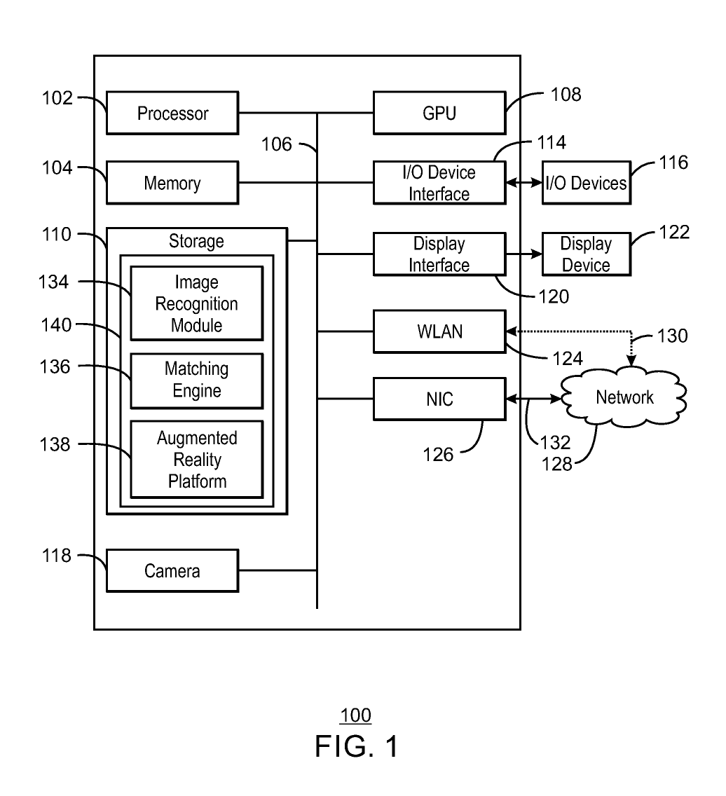

FIG. 1 is an example block diagram of a computer device 100 for the implementation of multiple triggers from an image into a videogame platform. The computer device 100 may be, for example, a smartphone, a computing tablet, a laptop computer, or a desktop computer, among others. The computer device 100 may include a processor 102 that is configured to execute stored instructions, as well as a memory device 104 that stores instructions that are executable by the processor 102. The processor 102 can be a single core processor, a dual-core processor, a multi-core processor, a computing cluster, or the like. The processor 102 may be coupled to the memory device 104 by a bus 106 where the bus 106 may be a communication system that transfers data between various components of the computer device 100. In embodiments, the bus 106 may be a PCI, ISA, PCI-Express, HyperTransport®, NuBus, or the like.

The memory device 104 can include random access memory (RAM), e.g., SRAM, DRAM, zero capacitor RAM, eDRAM, EDO RAM, DDR RAM, RRAM, PRAM, read only memory (ROM), e.g., Mask ROM, PROM, EPROM, EEPROM, flash memory, or any other suitable memory systems. The computer device 100 may also include a graphics processing unit (GPU) 108. As shown, the processor 102 may be coupled through the bus 106 to the GPU 108. The GPU 108 may be configured to perform any number of graphics operations within the computer device 100. For example, the GPU 108 may be configured to render or manipulate graphic images, graphic frames, videos, or the like, that may be displayed to a user of the computer device 100. The computer device 100 may also include a storage device 110. The storage device 110 may include non-volatile storage devices, such as a solid-state drive, a hard drive, an optical drive, a flash drive, an array of drives, or any combinations thereof.

The processor 102 may be connected through the bus 106 to an input/output (I/O) device interface 114 configured to connect the computer device 100 to one or more I/O devices 116. The I/O devices 116 may include, for example, a keyboard, a mouse, or a pointing device, wherein the pointing device may include a touchpad or a touchscreen, among others. The I/O devices 116 may be built-in components of the computer device 100, or located externally to the computer device 100.

The processor 102 may also be linked through the bus 106 to a camera 118 to capture an image, where the captured image may be stored to the memory device 104. The processor 102 may also be linked through the bus 106 to a display interface 120 configured to connect the computer device 100 to display devices 122. A display device 122 may be a built-in component of the computer device 100, or connected externally to the computer device 100. The display device 122 may also include a display screen of a smartphone, a computing tablet, a computer monitor, a television, or a projector, among others. As a result of using the camera 118, the captured image may be viewed on the display screen of the display device 122 by a user. In some embodiments, the display screen may include a touch screen component, e.g., a touch-sensitive display. The touch screen component may allow a user to interact directly with the display screen of the display device 122 by touching the display screen with a pointing device, one or more fingers, or a combination of both.

A wireless local area network (WLAN) 124 and a network interface controller (NIC) 126 may also be linked to the processor 102. The WLAN 124 may link the computer device 100 to a network 128 through a radio signal 130. Similarly, the NIC 126 may link the computer device 100 to the network 128 through a physical connection, such as a cable 132. Either network connection 124 or 126 allows the computer device to network with resources, such as the Internet, printers, fax machines, email, instant messaging applications, and with files located on storage servers.

The storage device 110 may include a number of modules configured to provide the computer device 100 with AR functionality. For example, an image recognition module 134 may be utilized to identify an image. The image recognition module 134 may be used, for example, to analyze an image and detect points of interest or fiducial markers using feature detection or other image processing methods. A fiducial is an object used in the field of view of an imaging system that appears in a produced image, and can be used as a point of reference or a measure. The interest points or markers can be used as a basis for tracked objects or triggers. In some examples, the image recognition module 134 need not be on the device itself, but may be hosted separately and contacted over the network 128.

A matching engine 136 may be utilized to match the image and its interest points to triggers, which are objects from the image that are tracked. In embodiments discussed herein, the triggers can be used subsequently as customizable components of a videogame that increase gameplay longevity and enhance user interaction for relatively simple videogames. Each tracked object or trigger will have an associated augmented reality overlay that is pre-defined by developers of the videogame software.

An augmented reality platform 138 may process input from the matching engine 136, and use image and pattern recognition technology to superimpose content, e.g., 3D models and video, over the initial static image and the triggers obtained therefrom. The superposition may be triggered when the image recognition module 134 recognizes an image and when triggers are identified by the matching engine 136. The overlay information that is desired can be superimposed over the image from the camera through using the augmented reality platform 138. Thus, a videogame environment running on the computer device 100 can be placed as an overlay relative to an image being tracked. The three modules 134, 136, and 138, can make up an augmented gaming platform 140.

Depending on the particular development of a target videogame, trigger items may interact with each other in a predefined manner. A developer, or a user, can have triggers defined in-game, specifically, where and how a particular trigger functions relative to virtual constructions and other triggers in the game. The more triggers that are defined, the more customizable a videogame becomes for a user. The user can manipulate the environment from which the stored image is generated, thus enabling the user to add or remove a number of triggers in endlessly customizable arrangements designed to effect gameplay. In this way, a user is given the freedom to define the solution to a particular videogame, add elements in the form of recognized triggers that make the game more or less difficult, and perform other arrangements of triggers that can change the manner a user experiences the videogame.

The block diagram of FIG. 1 is not intended to indicate that the computer device 100 is to include all of the components shown in FIG. 1. Further, any number of additional components may be included within the computer device 100, depending on the details of the specific implementation of the AR techniques and customizable videogame environment described herein. For example, the modules discussed are not limited to the functionalities mentioned, but the functions could be done in different places, or by different modules, if at all.

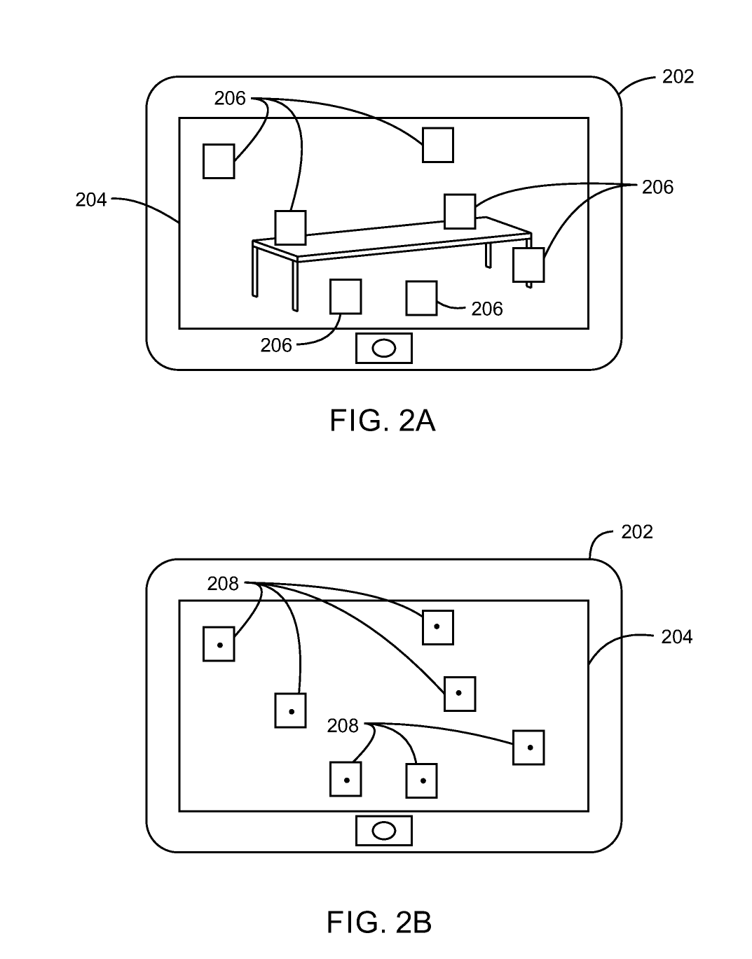

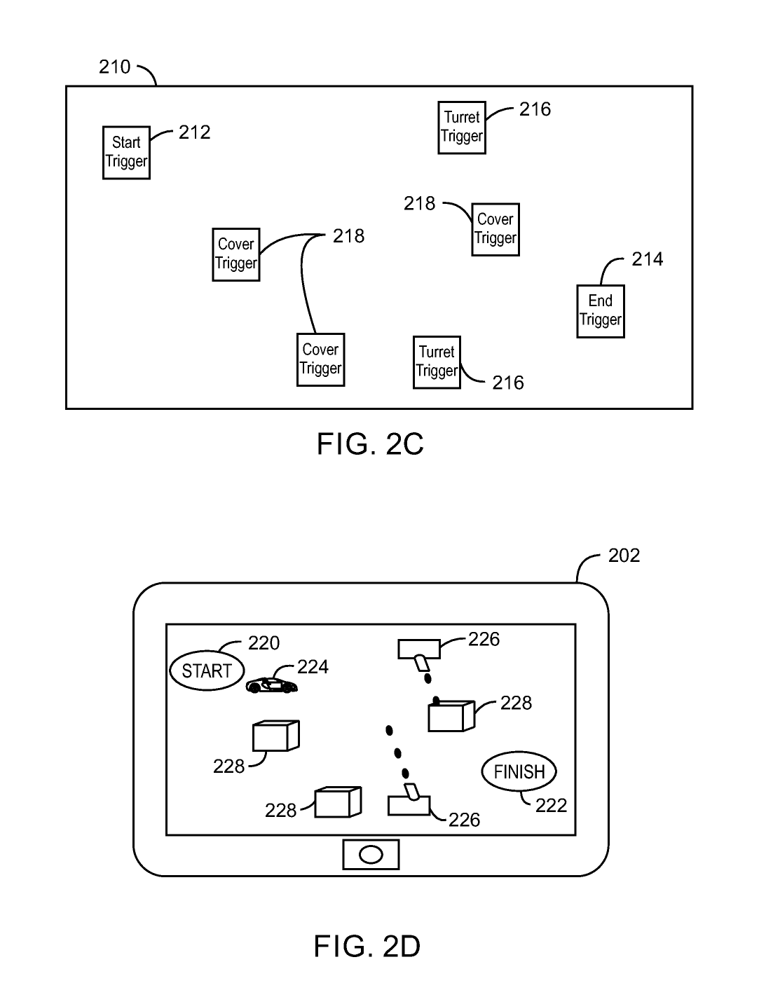

FIGS. 2A-2D illustrate an example sequence of capturing and tracking objects from an image taken by a computer device, and implementing the tracked objects on a videogame platform. FIG. 2A illustrates a computer device 202, for example, a tablet or smart phone, with camera that takes an image 204 of the background environment with real-world objects 206, and stores the image 204. The image 204 is then displayed on the display area of the computer device 202. The computer device 202 may be as described with respect to FIG. 1. The display area of the computer device 202 may include a touch screen component.

FIG. 2B illustrates the computer device 202 with the multiple objects from the image 204 that is stored in the computer device 202. The image 204 may be used as an input for a matching engine (not shown) that matches triggers 208 from real-world objects 206 in the image 204. The image 204 used for the recognition and tracking of objects or triggers may be static. As used herein, a static image is a visual image that does not move, e.g., a photograph, a poster, a newspaper, a painting, among other still images. When the matching engine has analyzed the image 204, triggers 208 are established that relate to the position of real-world objects 206 from the surrounding environment.

Triggers 208 may also be considered tracked objects. An augmented gaming platform capable of multi-object tracking is used to track the real-world objects 206, each of which will have an associated augmented reality overlay, which is specific to the videogame created by the developer. In this way, an overlay can be returned that may be ultimately used in a videogame environment implemented on the computer device 202.

FIG. 2C illustrates an example of how a particular videogame has been developed to incorporate triggers 208 from an image 204. A videogame platform 210 is configured to allow a user to define different triggers 208, or triggers 208 can be predefined by developers as to what trigger 208 is linked to what in-game function and how they are to be incorporated into the objective of the videogame. In addition to potentially defining the nature of the trigger 208, the user may define the particular placement of a trigger with respect to other triggers 208 and virtual items that will be implemented by the videogame platform 210. In this example, the videogame is related to guiding a virtual car avatar (not shown) from a start trigger 212 to an end trigger 214. The user thus is able to define the solution to the particular videogame based on how the user changes real-world objects 206 that are captured in the image 204 taken by the user, tracked as a trigger 208, and used as an overlay by the videogame platform 210.

In the virtual car example of FIG. 2C, there are additional triggers that have been designated as turret triggers 216. The turret triggers are configured to fire virtual shells at the virtual car avatar. Cover triggers 218 are also incorporated in this simple example videogame, which block the virtual shells. In this embodiment, the user can add or remove the number of triggers 216 and 218, or change their relative positioning in order to alter the videogame environment, thus adding different levels of complexity and customizability to the user's gaming experience.

The location of real life, tracked objects relative to virtual objects created by the developer and controlled by the user can be used to create interactions in a videogame. The user's ability to move the real life objects allows for increased variety in the videogame, with the experience being different dependent on the user's choice of location for the tracked objects.

FIG. 2D illustrates the computer device 202 executing software from the videogame platform 210 described in FIG. 2C and displaying the animation in the display area. The start trigger 212 and end trigger 214 have been recognized by the game and incorporated into the overlay of the 3D game as a user plays. The start area 220 and finish area 222 are now user-defined solutions that a virtual racecar avatar 224 must navigate. The virtual racecar avatar 224 is operatively controlled by the user through manipulating a controller connected peripherally to the computer device 202, or through manipulating the touch screen of the computer device 202, or the orientation of the computer device 202 itself. In embodiments of the current technology, the user is proactively changing the way the videogame is played and how virtual problems are solved. Thus, a user actively defines a particular solution or setup dependent on the placement of real-world objects, and is able to experience a videogame based on the solution established by the user.

In the videogame shown in FIG. 2D, the turret triggers 214 are now shown as virtual turrets 226 on the display area of the computer device 202. The virtual turrets 226 are configured to fire virtual shells at the virtual racecar avatar 224. The other objects that were tracked and designated as triggers include the cover triggers 216, which the game interprets as areas of cover 228 that the operator of the virtual racecar avatar 224 may utilize to avoid virtual shells being fired by the virtual turrets 226.

An augmented gaming platform, such as the augmented videogame platform 140 of FIG. 1, may be used to superimpose the videogame environment, including a trigger 208, over the image 204. The augmented gaming platform may be a software program, such as the image recognition engine 134, matching engine 136, and augmented reality platform 138, described with respect to FIG. 1.

A typical augmented gaming platform may use camera technology to recognize a real-world environment, including images and objects within the environment, and to overlay digital and virtual information onto the real-world environment. However, in the present disclosure, the user may access the augmented gaming platform from the computer device 202 and then point the device 202 at the image 204, e.g., the static image that embodies no movement. By pointing the computer device 202 towards the image 204, the image recognition software determines that a trigger 208 from the image 204 is in view of the camera, and then retrieves and activates a matching engine in the device 208 so that the augmented gaming platform may overlay graphics from videogame platform 210 onto the image 204 that is being tracked. When viewed from the display screen of the computer device 202, entities in the virtual environment on the videogame platform 210 based on triggers 208 from the image 204 create a readily customizable videogame experience for the user.

The sequence depicted by FIGS. 2A-2D is not intended to indicate that the sequence is to include all of the components shown in FIGS. 2A-2D. Further, any number of additional components may be included within the sequence, depending on the details of the specific implementation.

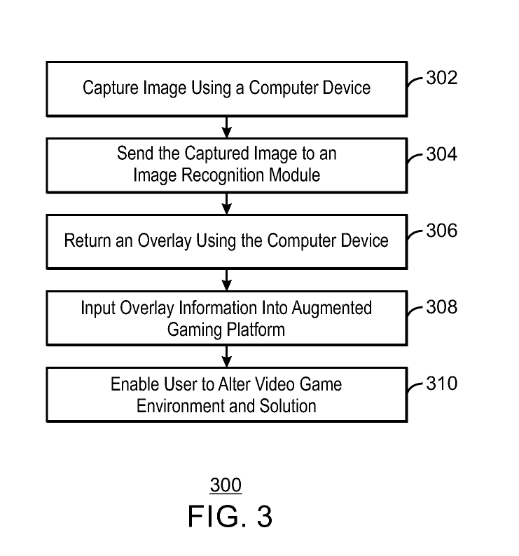

FIG. 3 is an example process flow diagram of a method 300 for creating a customizable videogame environment. The method 300 may be implemented, for example, by the computer devices 100 or 202 described with respect to FIGS. 1 and 2. The computer device can be pointed at the image it is to capture, recognize the image, and ultimately insert a trigger generated from the image into a videogame platform. The method 300 begins at block 302, where an image may be captured using a computer device. In particular, the computer device may implement a camera as an image capturing device. At block 304, the computing device sends the captured image to an image recognition module, such as image recognition module 134 from FIG. 1. The image recognition module can be used to analyze an image and detect points of interest or fiducial markers using feature detection or other image processing methods.

At block 306, a matching engine is configured to overlay a trigger in the videogame on a real-world object in the captured image. Overlay information can be returned by the matching engine. An AR platform can be implemented by the computer device to draw the overlay into the videogame platform, and each tracked object or trigger will have an associated AR overlay. The triggers are tracked using multiple-object tracking techniques.

At block 308, the AR platform can input the overlay information into the augmented gaming platform. A trigger is also used in the overlay of the augmented gaming platform and becomes part of a virtual videogame environment running on the computer device. Thus, the real-world objects stored in the image can be rearranged by a user and add customizable variety to a videogame environment, because of incorporating triggers that correspond to real-world objects.

At block 310, the user is enabled to alter the videogame environment that is experienced on the computer device. Using the method 300 and techniques described herein, a user is enabled to alter what the solution to a particular videogame can be. This empowers the user to create different levels and experiences, with different problems and solutions, within the videogame environment, based on a captured image of a real-world environment.

The process flow diagram in FIG. 3 is not intended to indicate that the process flow diagram 300 is to include all of the components shown in FIG. 3. Further, the process flow diagram 300 may include fewer or more blocks than what is shown, depending on the details of the specific implementation.

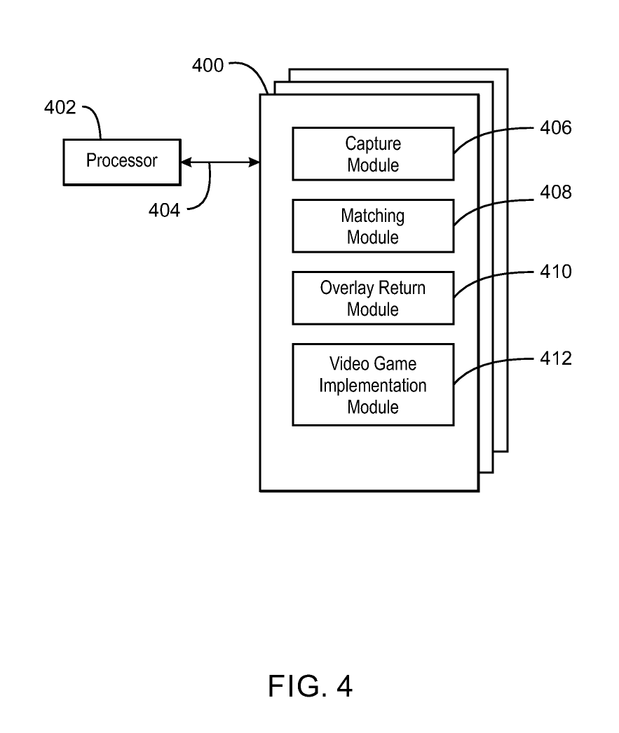

FIG. 4 is an example block diagram showing a non-transitory, computer-readable media 400 that holds code that enables the customizability of a videogame environment. The computer-readable media 400 may be accessed by a processor 402 over a system bus 404. The code may direct the processor 402 to perform the steps of the current method as described with respect to FIG. 3.

Additionally, the various components of a computer device 100, such as the computer device 100 discussed with respect to FIG. 1, may be stored on the non-transitory, computer-readable media 400, as shown in FIG. 4. For example, a capture module 406 may be configured to capture an image using the computer device. The image may be a static image such as a photograph of a real-world environment. A matching module 408 may be configured to match a number of triggers to real-world objects depicted in the image obtained by the capture module 406. In particular, the image can be sent to the matching module 408 of the computer device, and triggers can be matched to multiple real-world objects. The real-world objects captured in the image may be tracked using multi-object tracking techniques.

An overlay return module 410 may be configured to superimpose an overlay based on triggers defined by an AR platform. The overlay can be entered into a videogame software platform running on the computer device using a videogame implementation module 412. The videogame implementation module 412 enables a user to add customizable variety to an interactive videogame environment based on how real-world objects in the captured image are arranged. User customizability results from the ability to capture different images having various orientations of real-world objects, which are tracked has triggers and associated with an augmented reality overlay. Depending on how the videogame platform was developed, the various triggers based on real-world objects can be defined in various ways virtually in the videogame environment.

The block diagram of FIG. 4 is not intended to indicate that the computer-readable media 400 is to include all of the components or modules shown in FIG. 4. Further, any number of additional components may be included within the computer-readable media 400, depending on the details of the specific implementation of the AR techniques and customizing an augmented gaming platform described herein.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A method for an augmented gaming platform, comprising:
capturing an image using a computer device with a camera and a display;
sending the image to a matching engine, wherein a trigger is matched to an object in the image;
returning, by the matching engine, an overlay based on the trigger; and
entering the overlay into an augmented gaming platform.

2. The method of claim 1, comprising:
pointing the computer device at the image;
recognizing the image; and
overlaying a trigger generated from the image into the augmented gaming platform.

3. The method of claim 1, further comprising tracking a trigger and overlaying the trigger into a videogame environment supported by the augmented gaming platform and displayed by the computer device.

4. The method of claim 3, further comprising tracking a trigger using multi-object tracking.

5. The method of claim 1, further comprising selecting the objects in the image that are matched to a trigger through a user-interface.

6. The method of claim 1, further comprising processing a number of triggers from an image, wherein the triggers are utilized by the augmented gaming platform to create individual virtual objects that a user interacts with in a videogame environment.

7. A computer device, comprising
a camera to capture an image;
a processor configured to execute instructions; and
a storage device that stores instructions, the storage device comprising code to direct the processor to:
capture the image using the computer device with the camera and a display;
recognize the image;
send the image to a matching engine, wherein a trigger is matched based on objects in the image;
return an overlay based on the trigger;
input the overlay into an augmented gaming platform;
track the trigger and overlay the trigger into a videogame environment; and
display the videogame environment on the display of the computer device.

8. The computer device of claim 7, comprising code configured to direct the processor to process a number of triggers from an image, wherein the triggers are utilized by the augmented gaming platform to create individual virtual objects that a user interacts with in a videogame environment.

9. The computer device of claim 7, comprising an augmented reality platform in the storage device, wherein the augmented reality platform is configured to associate an augmented reality overlay to each trigger.

10. The computer device of claim 9, wherein the augmented reality overlay is specific to the augmented gaming platform created by a developer.

11. The computer device of claim 7, wherein a user is to create a videogame environment that is customizable based on the image that is captured.

12. The computer device of claim 7, wherein the image is a static image.

13. A non-transitory, machine-readable medium comprising instructions that when executed by a processor cause the processor to:
recognize an image;
match a trigger based on objects in the image;
return an overlay based on the trigger;
enter the overlay into an augmented gaming platform; and
display an interactive videogame environment that is customizable based on the image.

14. The non-transitory, machine-readable medium of claim 13, further comprising instructions that when executed by a processor cause the processor to process a number of triggers from an image, wherein the triggers are utilized by the augmented gaming platform to create individual virtual objects that a user interacts with in a videogame environment.

15. The non-transitory, machine-readable medium of claim 13, further comprising instructions that when executed by a processor cause the processor to track a trigger using multi-object tracking.
